(19) United States
(12) Patent Application Publication
(10) Pub. No.: US 2026/0361414 A1
(43) Pub. Date: Nov. 12, 2026

(54) WAVELENGTH CONVERTER AND WAVELENGTH CONVERSION METHOD

(71) Applicant: NEC Corporation, Tokyo (JP)

(72) Inventors: John kenji David CLARK, Tokyo (JP); Toshifumi NAKAMURA, Tokyo (JP); Wakako YASUDA, Tokyo (JP)

(73) Assignee: NEC Corporation, Tokyo (JP)

(21) Appl. No.: 19/658,979

(22) Filed: Apr. 27, 2026

(30) Foreign Application Priority Data
May 8, 2025 (JP) 2025-078263

(51) Int. Cl. H04B 10/572; H04B 10/532; H04B 10/556; H04B 10/61

(52) U.S. Cl. CPC H04B 10/572; H04B 10/532; H04B 10/5561; H04B 10/613; H04B 10/6166

(57) ABSTRACT

A reception unit receives an input optical signal of a first wavelength, which is polarization-multiplexed and quadrature-phase-modulated, and demodulates the input optical signal into in-phase and quadrature-phase analog signals relevant to first and second polarizations. A transmission unit transmits an output optical signal of a second wavelength, which is polarization multiplexed and quadrature-phase modulated, and which is obtained by multiplexing in-phase and quadrature-phase optical signal of the first and second polarizations obtained by intensity-modulating light of the second wavelength based on the in-phase and quadrature-phase analog signals relevant to the first and second polarizations, respectively. In the output optical signal, a phase relationship between components of the in-phase and quadrature-phase analog signals relevant to the first and second polarizations are maintained in the same phase relationship.

### INCORPORATION BY REFERENCE

This application is based upon and claims the benefit of priority from Japanese patent application No. 2025-78263, filed on May 8, 2025, the disclosure of which is incorporated herein in its entirety by reference.

### TECHNICAL FIELD

The present disclosure relates to a wavelength converter and a wavelength conversion method.

### BACKGROUND ART

As a device used in an optical network, a wavelength converter for converting an optical signal of a certain wavelength into an optical signal of another wavelength is known. For example, as disclosed in JP 2024-036713 A, a wavelength converter is widely used that is configured to wavelength-convert a quadrature-phase-modulated optical signal including an in-phase (I) phase and a quadrature (Q) phase orthogonal to each other.

The wavelength converter converts the received optical signal into an analog signal by coherent detection, as disclosed in JP 2024-036713 A and JP 2016-152556 A. Then, by modulating light of a wavelength different from that of the received optical signal based on the converted analog signal, an optical signal having another wavelength is output. In coherent detection, a received signal is branched into two. Thereafter, by causing one branched optical signal to interfere with local oscillation light, an I-phase optical signal is generated. In addition, by causing the other branched optical signal to interfere with local oscillation light of which a phase is shifted by 90°, a Q-phase optical signal is generated. Then, by photoelectrically converting the I-phase and Q-phase optical signals, I-phase and Q-phase analog signals can be obtained.

### SUMMARY

In wavelength conversion of a dual-polarization quadrature-phase shift keying (DP-QPSK) optical signal, if a polarization axis is deviated in coherent detection at the time of DP-QPSK reception, the demodulated dual-polarized in-phase signal and quadrature-phase signal include projection of both polarization components of the optical signal. In a case where digital signal processing is performed between a reception unit and a transmission unit of the wavelength converter, the polarization components of the optical signal can be separated from the demodulated dual-polarized in-phase signal and quadrature-phase signal.

However, in wavelength converter of a so-called optical-analog-optical (OAO) system, a DP-QPSK optical signal of which a wavelength is converted based on analog signals of the dual-polarized in-phase signal and quadrature-phase signal is transmitted without performing compensation by digital signal processing. In this case, quality of the DP-QPSK optical signal to be transmitted may be deteriorated due to mixture of polarization component projections in the analog signal.

A wavelength converter according to an example aspect of the present disclosure includes: a reception means for receiving an input optical signal of a first wavelength, which is polarization-multiplexed and quadrature-phase-modulated, and demodulating the input optical signal into an in-phase analog signal and a quadrature-phase analog signal relevant to a first polarization, and an in-phase analog signal and a quadrature-phase analog signal relevant to a second polarization; and a transmission means for transmitting an output optical signal of a second wavelength different from the first wavelength, which is polarization-multiplexed and quadrature-phase-modulated, and which is obtained by multiplexing an in-phase optical signal of the first polarization obtained by intensity-modulating light of the second wavelength based on the in-phase analog signal relevant to the first polarization, a quadrature-phase optical signal of the first polarization obtained by intensity-modulating light of the second wavelength based on the quadrature-phase analog signal relevant to the first polarization, an in-phase optical signal of the second polarization obtained by intensity-modulating light of the second wavelength based on the in-phase analog signal relevant to the second polarization, and a quadrature-phase optical signal of the second polarization obtained by intensity-modulating light of the second wavelength based on the quadrature-phase analog signal relevant to the second polarization, wherein, in the output optical signal, a phase relationship between a component of the in-phase analog signal and a component of the quadrature-phase analog signal relevant to the first polarization and a phase relationship between a component of the in-phase analog signal and a component of the quadrature-phase analog signal relevant to the second polarization are maintained in the same phase relationship.

A wavelength conversion method according to an example aspect of the present disclosure, the method including: receiving an input optical signal of a first wavelength, which is polarization-multiplexed and quadrature-phase-modulated, and demodulating the input optical signal into an in-phase analog signal and a quadrature-phase analog signal relevant to a first polarization, and an in-phase analog signal and a quadrature-phase analog signal relevant to a second polarization; and transmitting an output optical signal of a second wavelength different from the first wavelength, which is polarization-multiplexed and quadrature-phase-modulated, and which is obtained by multiplexing an in-phase optical signal of the first polarization obtained by intensity-modulating light of the second wavelength based on the in-phase analog signal relevant to the first polarization, a quadrature-phase optical signal of the first polarization obtained by intensity-modulating light of the second wavelength based on the quadrature-phase analog signal relevant to the first polarization, an in-phase optical signal of the second polarization obtained by intensity-modulating light of the second wavelength based on the in-phase analog signal relevant to the second polarization, and a quadrature-phase optical signal of the second polarization obtained by intensity-modulating light of the second wavelength based on the quadrature-phase analog signal relevant to the second polarization, wherein, in the output optical signal, a phase relationship between a component of the in-phase analog signal and a component of the quadrature-phase analog signal relevant to the first polarization and a phase relationship between a component of the in-phase analog signal and a component of the quadrature-phase analog signal relevant to the second polarization are maintained in the same phase relationship.

According to the present disclosure, it is possible to convert an input optical signal into an output optical signal having a different wavelength while maintaining an orthogonal relationship of a plurality of signal components of the input optical signal that is polarization-multiplexed and quadrature-phase-modulated.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a diagram schematically illustrating a configuration of a wavelength converter according to one example embodiment;

FIG. 2 is a diagram schematically illustrating a configuration of a reception unit of the wavelength converter according to one example embodiment;

FIG. 3 is a diagram schematically illustrating a configuration of a transmission unit of the wavelength converter according to one example embodiment;

FIG. 4 is a diagram illustrating an influence in which projections of both polarized waves are mixed in an analog signal;

FIG. 5 is a diagram illustrating a constellation of an output optical signal in a case where a polarization axis of coherent detection is deviated with respect to a polarization axis of an input optical signal;

FIG. 6 is a diagram illustrating a relationship between an electric field of the output optical signal and the electric field of the input optical signal in cases of S_{X}=S_{Y} and S_{X}=−S_{Y};

FIG. 7 is a diagram illustrating first to fourth cases that are examples of a connection relationship between the reception unit and a driver;

FIG. 8 is a diagram illustrating a definition of an electric field of an optical signal in each unit of the transmission unit;

FIG. 9 is a diagram illustrating a relationship between a bias point of an MZ optical modulator and an electric field of an XI component;

FIG. 10 is a diagram illustrating a relationship between a bias point of a phase modulator related to an XQ component and an electric field of the XQ component; and

FIG. 11 is a diagram illustrating a constellation of the output optical signal after wavelength conversion by the wavelength converter according to one example embodiment.

### EXAMPLE EMBODIMENTS

Hereinafter, example embodiments of the present invention are described with reference to the drawings. In the drawings, the same elements are denoted with the same reference signs, and redundant description will be omitted as necessary.

Hereinafter, the term “one example embodiment” means that it is applicable to any of the example embodiments described below or to a combination of equal to or more than two example embodiments, and that the application is not limited to a specific example embodiment.

### FIRST EXAMPLE EMBODIMENT

A wavelength converter according to a first example embodiment is described. The wavelength converter according to the first example embodiment performs wavelength conversion of an optical-analog-optical (OAO) system on an optical signal subjected to dual-polarization quadrature phase-shift-keying (DP-QPSK) without applying digital signal processing.

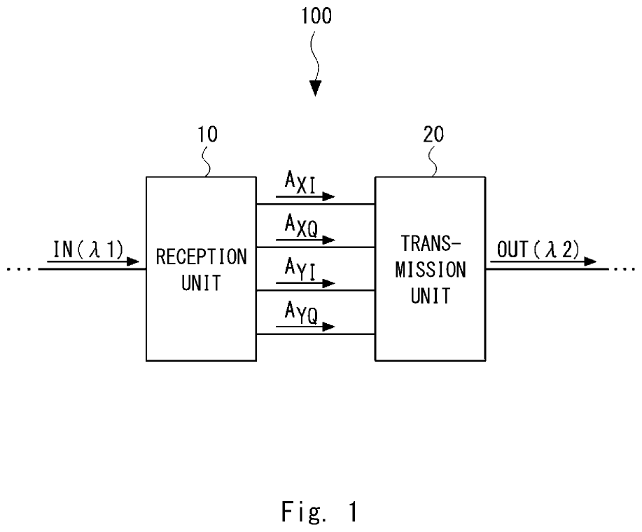

FIG. 1 is a diagram schematically illustrating a configuration of a wavelength converter according to one example embodiment. A wavelength converter 100 includes a reception unit 10 and a transmission unit 20. The reception unit 10 is configured as a so-called coherent reception front end of the wavelength converter 100. The transmission unit 20 is configured as a so-called coherent transmission front end of the wavelength converter 100.

The reception unit 10 receives an input of a DP-QPSK-modulated input optical signal IN having a wavelength λ1. Hereinafter, the wavelength λ1 is also referred to as a first wavelength. The reception unit 10 outputs in-phase (I-phase) and quadrature-phase (Q-phase) analog signals for an X-polarized wave and a Y-polarized wave by coherently detecting the input optical signal IN. Note that, hereinafter, the I-phase of the X-polarized wave is referred to as XI, and the Q-phase is referred to as XQ. The I-phase of the Y-polarized wave is referred to as YI, and the Q-phase is referred to as YQ. Hereinafter, one of the X-polarized wave and the Y-polarized wave is also referred to as a first polarized wave, and the other is also referred to as a second polarized wave.

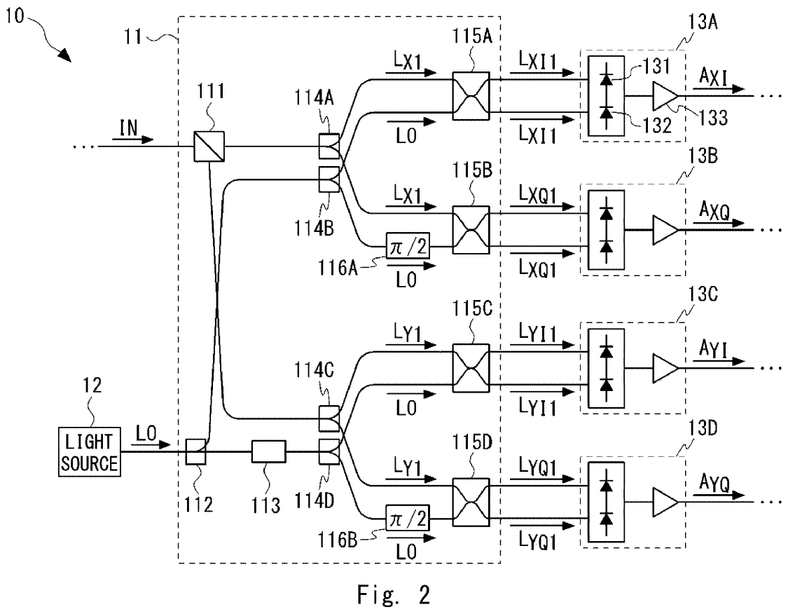

A configuration of the reception unit 10 will be described. FIG. 2 is a diagram schematically illustrating a configuration of the reception unit of the wavelength converter according to one example embodiment. The reception unit 10 includes a 900 hybrid circuit 11, a light source 12, and photoelectric converters 13A to 13D.

The 90° hybrid circuit 11 includes a polarizing beam splitter (PBS) 111, a 1×2 optical coupler 112, a polarization rotator 113, 1×2 optical couplers 114A to 114D, 2×2 optical couplers 115A to 115D, and phase shifters 116A and 116B.

The PBS 111 performs polarization separation on the input optical signal IN into an X-polarized wave optical signal L_{XI} and a Y-polarized wave optical signal L_{YI}. The X-polarized wave optical signal L_{XI} is branched into the 2×2 optical coupler 115A and the 2×2 optical coupler 115B by the 1×2 optical coupler 114A. The Y-polarized wave optical signal L_{YI} is branched into the 2×2 optical coupler 115C and the 2×2 optical coupler 115D by the 1×2 optical coupler 114C.

The light source 12 is configured as, for example, a wavelength variable laser light source and outputs local oscillation light LO having the wavelength λ1. The local oscillation light LO is branched into the 1×2 optical coupler 114B and the polarization rotator 113 by the 1×2 optical coupler 112. The 1×2 optical coupler 114B branches the input local oscillation light LO into the 2×2 optical coupler 115A and the phase shifter 116A. The phase shifter 116A applies a phase shift of 90° to the input local oscillation light LO and then outputs the local oscillation light LO to the 2×2 optical coupler 115B. The polarization rotator 113 rotates a polarization plane of the local oscillation light LO by 90° and then outputs the local oscillation light LO to the 1×2 optical coupler 114D. The 1×2 optical coupler 114D branches the input local oscillation light LO after polarization rotation into the 2×2 optical coupler 115C and the phase shifter 116B. The phase shifter 116B applies a phase shift of 90° to the input local oscillation light LO and then outputs the local oscillation light LO to the 2×2 optical coupler 115D.

The 2×2 optical coupler 115A outputs an XI optical signal L_{XI1} obtained by causing the X-polarized wave optical signal L_{XI} and the local oscillation light LO to interfere with each other to the photoelectric converter 13A via two output ports. The 2×2 optical coupler 115B outputs an XQ optical signal L_{XQ1} obtained by causing the X-polarized wave optical signal L_{XI} and the local oscillation light LO to which a phase shift of 90° is applied to interfere with each other to the photoelectric converter 13B via two output ports. The 2×2 optical coupler 115C outputs a YI optical signal L_{YI1} obtained by causing the Y-polarized wave optical signal L_{YI} and the local oscillation light LO to interfere with each other to the photoelectric converter 13C via two output ports. The 2×2 optical coupler 115D outputs a YQ optical signal L_{YQ1} obtained by causing the Y-polarized wave optical signal L_{YI} and the local oscillation light LO to which a phase shift of 90° is applied to interfere with each other to the photoelectric converter 13D via two output ports.

The photoelectric converters 13A to 13D are each configured as a balance type detector in which two photodiodes (hereinafter, referred to as PD) are connected in cascade. Here, a PD 131 on the upper side of the drawing is defined as the + side, and a PD 132 on the lower side of the drawing is defined as the − side. The photoelectric converters 13A to 13D receive the XI optical signal L_{XI1}, the XQ optical signal L_{XQ1}, the YI optical signal L_{YI1}, and the YQ optical signal L_{YQ1} output from two output ports of the 2×2 optical couplers 115A to 115D. Also, the photoelectric converters 13A to 13D convert current signals output from a node between the two PDs 131 and 132 into analog signals A_{XI}, A_{XQ}, A_{YI}, and A_{YQ} of XI, XQ, YI, and YQ by, for example, a transimpedance amplifier 133.

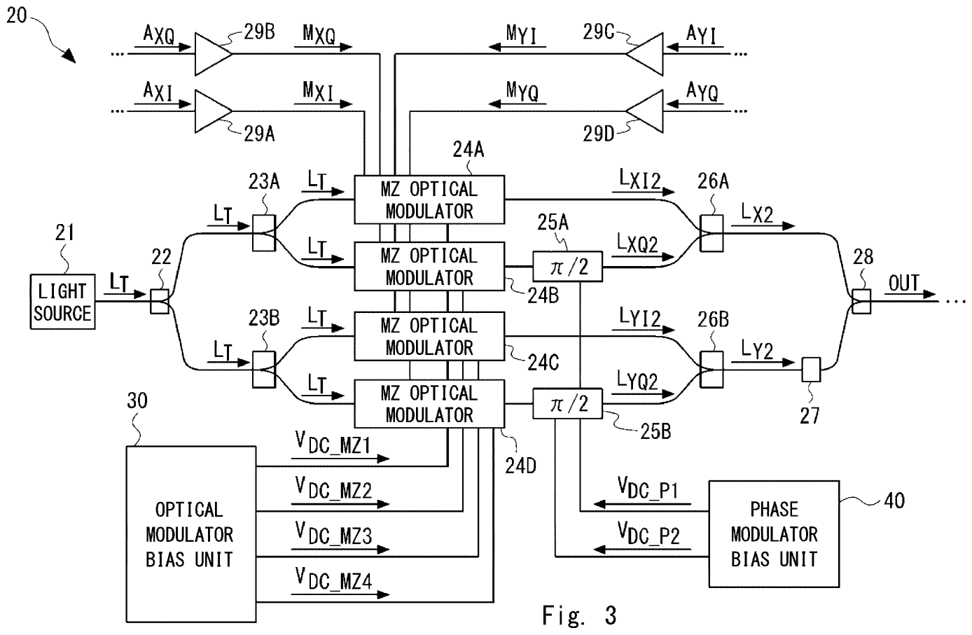

Next, a configuration of the transmission unit 20 will be described. FIG. 3 is a diagram schematically illustrating a configuration of the transmission unit of the wavelength converter according to one example embodiment. The transmission unit 20 outputs a DP-QPSK-modulated output optical signal OUT by modulating light of a wavelength λ2 based on the analog signals A_{XI}, A_{XQ}, A_{YI}, and A_{YQ}. Hereinafter, the wavelength λ2 is also referred to as a second wavelength.

The transmission unit 20 is configured with a light source 21, 1×2 optical couplers 22, 23A, and 23B, Mach-Zehnder optical modulators (hereinafter, MZ optical modulators) 24A to 24D, phase modulators 25A and 25B, 2×1 optical couplers 26A and 26B, a polarization rotator 27, a polarization beam coupler 28, drivers 29A to 29D, an optical modulator bias unit 30, and a phase modulator bias unit 40.

The light source 21 is configured as, for example, a wavelength variable laser light source and outputs transmission light L_{T} having the wavelength λ2 to the 1×2 optical coupler 22. The 1×2 optical coupler 22 branches the transmission light L_{T} into the 1×2 optical coupler 23A and the 1×2 optical coupler 23B. The 1×2 optical coupler 23A branches the input transmission light L_{T} into the MZ optical modulator 24A and the MZ optical modulator 24B. The 1×2 optical coupler 23B branches the input transmission light L_{T} into the MZ optical modulator 24C and the MZ optical modulator 24D.

Each of the MZ optical modulators 24A to 24D branches the transmission light L_{T} into two arms. Hereinafter, the MZ optical modulators 24A to 24D are also referred to as first to fourth optical modulators, respectively. Although not illustrated, electrodes for applying a modulation signal and a bias voltage are provided in two arms of each of the MZ optical modulators 24A to 24D. For example, in the MZ optical modulators 24A to 24D, a pair of two electrodes provided in each of the two arms may be provided. In addition, an electrode for applying the modulation signal and an electrode for applying the bias voltage may be separately provided in each arm.

The drivers 29A to 29D apply modulation signals M_{XI}, M_{XQ}, M_{YI}, and M_{YQ} for driving the MZ optical modulators 24A to 24D to the MZ optical modulators 24A to 24D, respectively, based on the analog signals A_{XI}, A_{XQ}, A_{YI}, and A_{YQ}. In addition, the optical modulator bias unit 30 applies bias voltages V_{DC_MZ1} to V_{DC_MZ4} for driving the MZ optical modulators 24A to 24D and controlling operating points of the MZ optical modulators 24A to 24D to the MZ optical modulators 24A to 24D. Hereinafter, the modulation signals M_{XI}, M_{XQ}, M_{YI}, and M_{YQ} are also referred to as first to fourth modulation signals, respectively. The bias voltages V_{DC_MZ1} to V_{DC_MZ4} are also referred to as first to fourth bias voltages, respectively. Adjustment of the bias voltages V_{DC_MZ1} to V_{DC_MZ4} applied to the MZ optical modulators 24A to 24D is hereinafter also referred to as adjustment of bias points of the MZ optical modulators 24A to 24D.

The phase modulator bias unit 40 applies bias voltages V_{DC_P1} and V_{DC_P2} for controlling phase shift amounts in the phase modulators 25A and 25B to the phase modulators 25A and 25B, respectively. Hereinafter, the bias voltages V_{DC_P1} and V_{DC_P2} are also referred to as fifth and sixth bias voltages, respectively. In addition, adjustment of the bias voltages V_{DC_P1} and V_{DC_P2} applied to the phase modulators 25A and 25B is hereinafter also referred to as adjustment of bias points of the phase modulators 25A and 25B.

The MZ optical modulator 24A outputs an XI optical signal L_{XI2} having the wavelength λ2 obtained by modulating the transmission light L_{T} according to the modulation signal M_{XI} to the 2×1 optical coupler 26A. The MZ optical modulator 24B outputs an XQ optical signal L_{XQ2} having the wavelength λ2 obtained by modulating the transmission light L_{T} according to the modulation signal M_{XQ} to the phase modulator 25A. The phase modulator 25A applies a phase shift of 90° to the XQ optical signal L_{XQ2} according to the bias voltage V_{DC_P1}, and outputs the XQ optical signal L_{XQ2} to the 2×1 optical coupler 26A. As a result, the 2×1 optical coupler 26A multiplexes the XI optical signal L_{XI2} and the XQ optical signal L_{XQ2} of which a phase is delayed by 90° with respect to the XI optical signal L_{XI2} to an X-polarized wave optical signal L_{X2} subjected to phase shift modulation. The 2×1 optical coupler 26A outputs the X-polarized wave optical signal L_{X2} to the polarization beam coupler 28.

The MZ optical modulator 24C outputs a YI optical signal L_{YI2} having the wavelength λ2 obtained by modulating the transmission light L_{T} according to the modulation signal M_{YI} to the 2×1 optical coupler 26B. The MZ optical modulator 24D outputs a YQ optical signal L_{YQ2} having the wavelength λ2 obtained by modulating the transmission light L_{T} according to the modulation signal M_{YQ} to the phase modulator 25B. The phase modulator 25B applies a phase shift of 90° to the YQ optical signal L_{YQ2} according to the bias voltage V_{DC_P2}, and outputs the YQ optical signal L_{YQ2} to the 2×1 optical coupler 26B. Hereinafter, the phase modulators 25A and 25B are also referred to as first and second phase modulators, respectively. As a result, the 2×1 optical coupler 26B multiplexes the YI optical signal L_{YI2} and the YQ optical signal L_{YQ2} of which a phase is delayed by 90° with respect to the YI optical signal L_{YI2} to a Y-polarized wave optical signal L_{Y2} subjected to phase shift modulation. The 2×1 optical coupler 26B outputs the Y-polarized wave optical signal L_{Y2} to the polarization rotator 27. The polarization rotator 27 rotates a polarization plane of the Y-polarized wave optical signal L_{Y2} by 90° and outputs the signal to the polarization beam coupler 28.

The polarization beam coupler 28 multiplexes the X-polarized wave optical signal L_{X2} and the Y-polarized wave optical signal L_{Y2} to the DP-QPSK-modulated output optical signal OUT having the wavelength λ2. Then, the polarization beam coupler 28 outputs the output optical signal OUT.

As described above, the wavelength converter 100 can convert the DP-QPSK-modulated input optical signal IN having the wavelength λ1 into the DP-QPSK-modulated output optical signal OUT having the wavelength λ2.

In the wavelength converter 100, the input optical signal IN is subjected to polarization separation by the PBS 111. In general, it is difficult to make a polarization axis of an input polarization-multiplexed optical signal coincide with a polarization axis of a PBS. Therefore, an X-polarized wave separated by the PBS may include not only an X-polarized wave component of the input optical signal IN projected on an X polarization axis of the PBS but also a Y-polarized wave component projected on the X polarization axis of the PBS. Similarly, a Y-polarized wave separated by the PBS may include not only a Y-polarized wave component of the input optical signal IN projected on a Y polarization axis of the PBS but also an X-polarized wave component projected on the Y polarization axis of the PBS. Here, the polarization axis of the PBS is also referred to as a polarization axis in coherent detection. As a result, as described above, due to deviation between the polarization axis of the input optical signal IN and the polarization axis in coherent detection, a phenomenon occurs in which the analog signals A_{XI}, A_{XQ}, A_{YI}, and A_{YQ} include components of both polarizations.

Hereinafter, decomposition of polarization components of the input optical signal IN in the analog signals A_{XI}, A_{XQ}, A_{YI}, and A_{YQ} will be described. A complex electric field vector E_{IN} of the input optical signal IN is expressed by the following equation.

\vec{E_{IN}}=\vec{Eᵢ}e^{jω}^{ᵢ}^{t} [1]

Here, ωᵢ is a frequency of light of the input optical signal IN. t is time. j is the imaginary unit. Eᵢ is a complex amplitude vector of an electric field of the input optical signal IN. The complex amplitude vector Eᵢ of the electric field of the input optical signal IN is expressed by the following equation.

$$\vec{{E}_{i}} = ( {E}_{XI} ( t ) + {jE}_{XQ} ( t ) ) \text{?} + ( {E}_{YI} ( t ) + {jE}_{YQ} ( t ) ) \text{?} = [ \begin{matrix}{E}_{XI} ( t ) \\ {E}_{XQ} ( t ) \\ {E}_{YI} ( t ) \\ {E}_{YQ} ( t )\end{matrix} ] \qquad [ 2 ]$$

Here, E_{XI}(t), E_{XQ}(t), E_{YI}(t), and E_{YQ}(t) are amplitudes of XI, XQ, YI, and YQ, respectively. t is time. xᵢ and yᵢ are unit vectors in an X polarization direction and a Y polarization direction of the input optical signal IN, respectively.

A complex electric field vector E_{OUT} of the output optical signal OUT is expressed by the following equation.

\vec{E_{OUT}}=\vec{E_{O}}^{ejω}^{ₒ}^{t} [3]

Here, ω₀ is a frequency of light of the output optical signal OUT. t is time. Eₒ is a complex amplitude vector of an electric field of the output signal OUT. The complex amplitude vector Eₒ of the electric field of the output optical signal OUT is expressed by the following equation using a transfer matrix T_{WC} by wavelength conversion in the wavelength converter 100.

$$\vec{{E}_{o}} = {T}_{WC} \vec{{E}_{i}} \qquad [ 4 ]$$

$$\begin{matrix}{T}_{WC} = P ( Δ {ϕ}_{X} , {ΔΦ}_{Y} ) R ( Δ {θ}_{0} ) [ \begin{matrix}{S}_{XI} & 0 & 0 & 0 \\ 0 & {S}_{XQ} & 0 & 0 \\ 0 & 0 & {S}_{YI} & 0 \\ 0 & 0 & 0 & {S}_{YQ}\end{matrix} ] {T}_{R} & [ 5 ]\end{matrix}$$

$${T}_{R} = [ \begin{matrix}cos ( {Δθ}_{in} ) & 0 & - sin ( {Δθ}_{in} ) & 0 \\ 0 & cos ( {Δθ}_{in} ) & 0 & - sin ( {Δθ}_{in} ) \\ sin ( {Δθ}_{in} ) & 0 & cos ( {Δθ}_{in} ) & 0 \\ 0 & sin ( {Δθ}_{in} ) & 0 & cos ( {Δθ}_{in} )\end{matrix} ] \qquad [ 6 ]$$

In the above equation, P(Δ(φ_{X}, Δφ_{Y}) represents a phase shift due to wavelength conversion. R(Δθ₀) represents polarization rotation due to wavelength conversion. T_{R} is a transfer matrix obtained by receiving the input optical signal IN by the reception unit 10. Δθᵢₙ is an angle formed by the polarization axis of the input optical signal IN and the polarization axis of the PBS 111 of the reception unit 10. In Equation [5], a portion other than the transfer matrix T_{R} on the right side corresponds to components affected by transmission of the analog signal from the reception unit 10 to the transmission unit 20 and a transmission operation in the transmission unit 20. In the transfer matrix T_{R} obtained by receiving the input optical signal IN by the reception unit 10, an influence of a phase difference between the input signal and the local oscillation light, an optical frequency difference, and the like is omitted for simplification of description.

Here, for simplification of description, it is assumed that there is no phase shift and polarization rotation due to wavelength conversion. In this case, Equation [5] can be rewritten as follows.

$${T}_{WC} = [ \begin{matrix}{S}_{XI} & 0 & 0 & 0 \\ 0 & {S}_{XQ} & 0 & 0 \\ 0 & 0 & {S}_{YI} & 0 \\ 0 & 0 & 0 & {S}_{YQ}\end{matrix} ] {T}_{R} \qquad [ 7 ]$$

At this time, Equation [4] is expressed as follows using Equations [6] and [7].

$$\vec{{E}_{o}} = [ \begin{matrix}{S}_{XI} cos ( {Δθ}_{in} ) & 0 & - {S}_{XI} sin ( {Δθ}_{in} ) & 0 \\ 0 & {S}_{XQ} cos ( {Δθ}_{in} ) & 0 & - {S}_{XQ} sin ( {Δθ}_{in} ) \\ {S}_{YI} sin ( {Δθ}_{in} ) & 0 & {S}_{YI} cos ( {Δθ}_{in} ) & 0 \\ 0 & {S}_{YQ} sin ( {Δθ}_{in} ) & 0 & {S}_{YQ} cos ( {Δθ}_{in} )\end{matrix} ] \vec{{E}_{i}} \qquad [ 8 ]$$

Under the above assumption, an influence of mixture of projections of both polarization components in the analog signal will be examined. As an example, it is assumed that a phase relationship between S_{XI} and S_{XQ} is different from a phase relationship between S_{YI} and S_{YQ}. Here, it is assumed that S_{XI}=S_{XQ} and S_{YI}=−S_{YQ}. At this time, Equation [8] can be rewritten as follows.

$$\begin{matrix}\vec{{E}_{o}} & = [ \begin{matrix}{S}_{XI} cos ( {Δθ}_{in} ) & 0 & - {S}_{XI} sin ( {Δθ}_{in} ) & 0 \\ 0 & {S}_{XI} cos ( {Δθ}_{in} ) & 0 & - {S}_{XI} sin ( {Δθ}_{in} ) \\ {S}_{YI} sin ( {Δθ}_{in} ) & 0 & {S}_{YI} cos ( {Δθ}_{in} ) & 0 \\ 0 & - {S}_{YI} sin ( {Δθ}_{in} ) & 0 & - {S}_{YI} cos ( {Δθ}_{in} )\end{matrix} ] \vec{{E}_{i}} \\ & = [ \begin{matrix}{S}_{XI} cos ( {Δθ}_{in} ) & 0 & - {S}_{XI} sin ( {Δθ}_{in} ) & 0 \\ 0 & {S}_{XI} cos ( - {Δθ}_{in} ) & 0 & {S}_{XI} sin ( - {Δθ}_{in} ) \\ {S}_{YI} sin ( {Δθ}_{in} ) & 0 & {S}_{YI} cos ( {Δθ}_{in} ) & 0 \\ 0 & {S}_{YI} sin ( - {Δθ}_{in} ) & 0 & - {S}_{YI} cos ( - {Δθ}_{in} )\end{matrix} ] \vec{{E}_{i}}\end{matrix} \qquad [ 9 ]$$

As described above, the influence of the mixture of the projections of both polarization components in the analog signal in the output optical signal OUT is expressed as rotation of the XI component, the XQ component, the YI component, and the YQ component of the input optical signal IN.

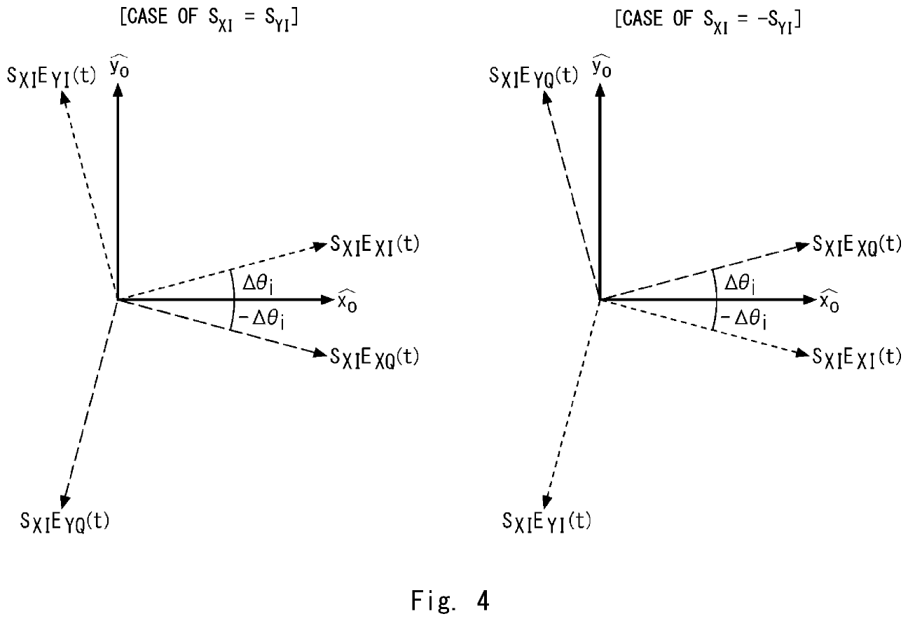

FIG. 4 is a diagram illustrating an influence in which projections of both polarized waves are mixed in an analog signal. In this example, a polarization axis of an I component rotates by Δθᵢ in the counterclockwise direction with respect to polarization axes xₒ and yₒ of the output optical signal OUT. On the other hand, a polarization axis of a Q component rotates by Δθᵢ in the clockwise direction with respect to the polarization axes xₒ and yₒ of the output optical signal OUT. That is, in a four-phase optical signal multiplexed by the polarization beam coupler 28, the polarization axis of the I component and the polarization axis of the Q component rotate in opposite directions to each other with respect to the polarization axes xₒ and yₒ of the output optical signal OUT at the time of multiplexing. As a result, it is not possible to maintain orthogonal states of XI, XQ, YI, and YQ, and quality as the DP-QPSK signal deteriorates.

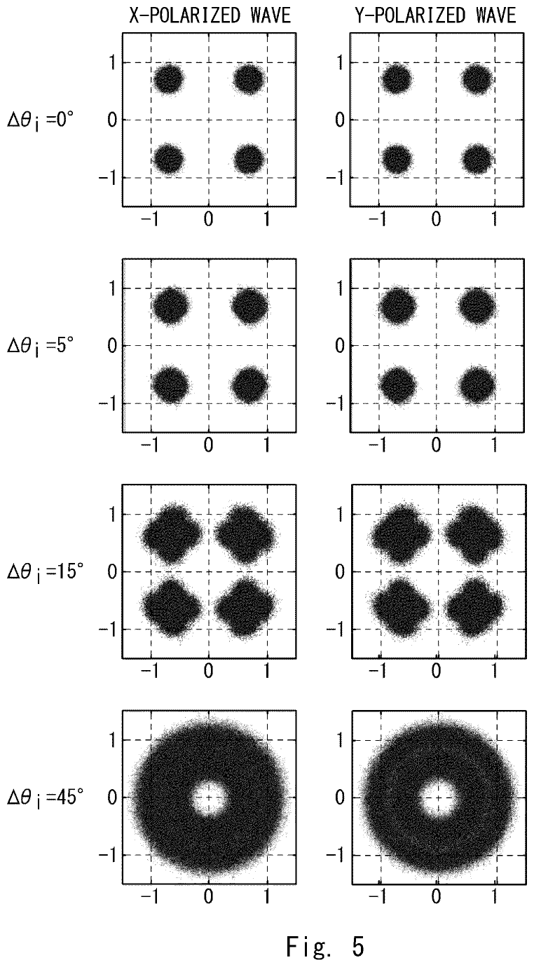

FIG. 5 is a diagram illustrating a constellation of an output optical signal in a case where a polarization axis of coherent detection is deviated with respect to a polarization axis of an input optical signal. As illustrated in FIG. 5, it can be seen that signal quality deteriorates in accordance with the deviation of the polarization axis of the coherent detection with respect to the polarization axis of the input optical signal IN.

As described above, in order to maintain the signal quality of the output optical signal OUT as a DP-QPSK optical signal, it is required for the polarization axis of the I component to coincide with the polarization axis of the Q component. Hereinafter, for simplification of description, it is assumed that there is no phase shift and polarization rotation due to wavelength conversion as described above. In order to make the polarization axis of the I component coincide with the polarization axis of the Y component of the output optical signal OUT, the phase relationship between S_{XI} and S_{XQ} may be the same as the phase relationship between S_{YI} and S_{YQ} in Equation [7]. That is, in Equation [7], S_{XI}=S_{X}=S_{XQ} and S_{YI}=S_{Y}=S_{YQ}, or S_{XI}=S_{X}=−S_{XQ} and S_{YI}=S_{Y}=−S_{YQ} may be satisfied. In this case, Equation [7] can be rewritten as follows.

$${T}_{WC} = [ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] {T}_{R} \qquad [ 10 ]$$

Therefore, the complex amplitude vector Eₒ of the electric field of the output optical signal OUT is expressed by the following equation.

$$\begin{matrix}\vec{{E}_{o}} & = [ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] [ \begin{matrix}cos ( {Δθ}_{in} ) & 0 & - sin ( {Δθ}_{in} ) & 0 \\ 0 & cos ( {Δθ}_{in} ) & 0 & - sin ( {Δθ}_{in} ) \\ sin ( {Δθ}_{in} ) & 0 & cos ( {Δθ}_{in} ) & 0 \\ 0 & sin ( {Δθ}_{in} ) & 0 & cos ( {Δθ}_{in} )\end{matrix} ] \vec{{E}_{i}} \\ & = [ \begin{matrix}{S}_{X} cos ( {Δθ}_{in} ) & 0 & - {S}_{X} sin ( {Δθ}_{in} ) & 0 \\ 0 & \pm {S}_{X} cos ( {Δθ}_{in} ) & 0 & ∓ {S}_{X} sin ( {Δθ}_{in} ) \\ {S}_{Y} sin ( {Δθ}_{in} ) & 0 & {S}_{Y} cos ( {Δθ}_{in} ) & 0 \\ 0 & \pm {S}_{Y} sin ( {Δθ}_{in} ) & 0 & \pm {S}_{Y} cos ( {Δθ}_{in} )\end{matrix} ] \vec{{E}_{i}}\end{matrix} \qquad [ 11 ]$$

In the above equation, a case of S_{X}=S_{Y} and a case of S_{X}=−S_{Y} will be examined. In the case of S_{X}=S_{Y}, Equation [11] is rewritten to the following equation.

$$\vec{{E}_{o}} = [ \begin{matrix}{S}_{X} cos ( {Δθ}_{in} ) & 0 & - {S}_{X} sin ( {Δθ}_{in} ) & 0 \\ 0 & \pm {S}_{X} cos ( {Δθ}_{in} ) & 0 & ∓ {S}_{X} sin ( {Δθ}_{in} ) \\ {S}_{X} sin ( {Δθ}_{in} ) & 0 & {S}_{X} cos ( {Δθ}_{in} ) & 0 \\ 0 & \pm {S}_{X} sin ( {Δθ}_{in} ) & 0 & \pm {S}_{X} cos ( {Δθ}_{in} )\end{matrix} ] \vec{{E}_{i}} \qquad [ 12 ]$$

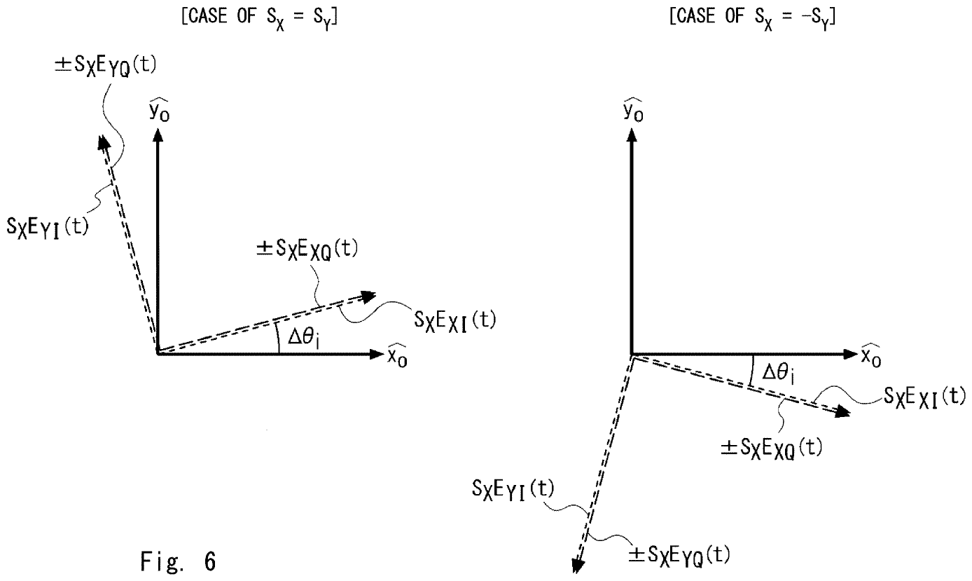

FIG. 6 is a diagram illustrating a relationship between the complex amplitude vector Eₒ of the electric field of the output optical signal OUT and the complex amplitude vector Eᵢ of the electric field of the input optical signal IN in the cases of S_{X}=S_{Y} and S_{X}=−S_{Y}. In this case, it can be understood that the polarization axis of the I component and the polarization axis of the Q component coincide with each other.

On the other hand, in the case of S_{X}=−S_{Y}, Equation [11] is rewritten as the following equation.

$$\vec{{E}_{o}} = [ \begin{matrix}{S}_{X} cos ( {Δθ}_{in} ) & 0 & - {S}_{X} sin ( {Δθ}_{in} ) & 0 \\ 0 & \pm {S}_{X} cos ( {Δθ}_{in} ) & 0 & ∓ {S}_{X} sin ( {Δθ}_{in} ) \\ - {S}_{X} sin ( {Δθ}_{in} ) & 0 & - {S}_{X} cos ( {Δθ}_{in} ) & 0 \\ 0 & ∓ {S}_{X} sin ( {Δθ}_{in} ) & 0 & ∓ {S}_{X} cos ( {Δθ}_{in} )\end{matrix} ] \vec{{E}_{i}} \qquad [ 13 ]$$

Also in this case, it can be understood that the polarization axis of the I component and the polarization axis of the Q component coincide with each other. The polarization axis of the output optical signal OUT in the case of S_{X}=−S_{y} is rotated clockwise by 2Δθᵢ as compared with the polarization axis of the output optical signal OUT in the case of S_{X}=S_{Y}.

Therefore, in the present example embodiment, the above-described phase relationship is realized by optimizing the transfer matrix in the transmission unit 20.

Here, the transfer matrix by the transmission of the analog signal from the reception unit 10 to the transmission unit 20 and the drivers 29A to 29D of the transmission unit 20 is defined as T_{RF}. The transfer matrix by intensity modulation in the MZ optical modulators 24A to 24D of the transmission unit 20 and phase modulation in the phase modulators 25A and 25B is defined as T_{MZ}. At this time, the transfer matrix T_{WC} is expressed by the following equation.

$${T}_{WC} = {T}_{MZ} {T}_{RF} {T}_{R} = P ( Δ {ϕ}_{X} , {ΔΦ}_{Y} ) R ( Δ {θ}_{0} ) [ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] {T}_{R} \qquad [ 14 ]$$

From Equation [14], in order to make the polarization axis of the I component and the polarization axis of the Q component coincide with each other in the output optical signal OUT, a product of T_{MZ} and T_{RF} is required to be a predetermined matrix. However, since the degree of freedom of each of T_{MZ} and T_{RF} is large, it is difficult to set the product of T_{MZ} and T_{RF} as a desired matrix.

For example, as long as the I component and the Q component of each of the X-polarized wave and the Y-polarized wave of the input optical signal IN are converted as components of the same polarized wave in the output optical signal OUT, the reception unit 10 and the drivers 29A to 29D can be freely connected.

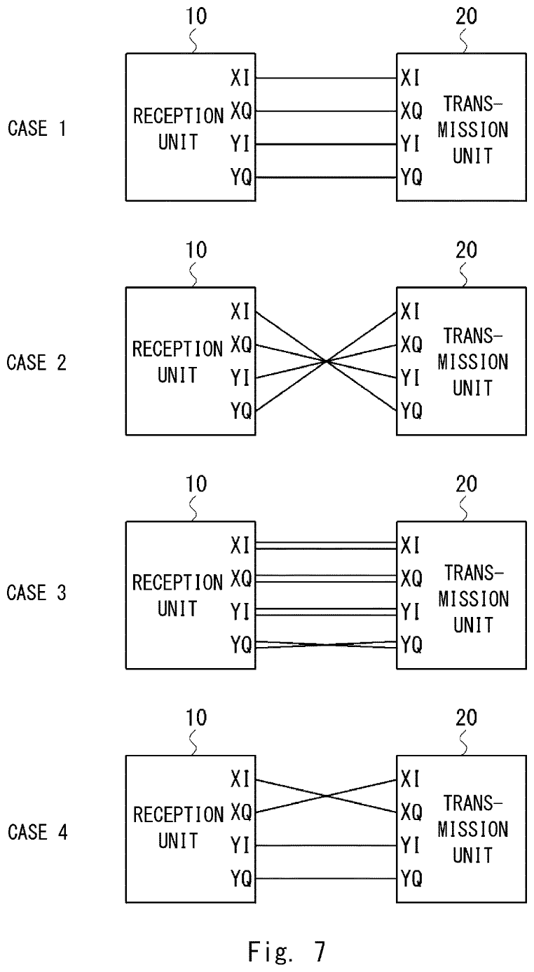

FIG. 7 is a diagram illustrating first to fourth cases that are examples of a connection relationship between the reception unit 10 and the drivers 29A to 29D. Case 1 is similar to the case of the wavelength converter 100 described above. In this case, the transfer matrix T_{RF} is expressed by the following equation.

$${T}_{RF} = [ \begin{matrix}1 & 0 & 0 & 0 \\ 0 & 1 & 0 & 0 \\ 0 & 0 & 1 & 0 \\ 0 & 0 & 0 & 1\end{matrix} ] \qquad [ 15 ]$$

Case 2 is a case where the analog signals A_{XI}, A_{XQ}, A_{YI}, and A_{XQ} are input to the drivers 29D to 29A in reverse order. In this case, the transfer matrix T_{RF} is expressed by the following equation.

$${T}_{RF} = [ \begin{matrix}0 & 0 & 0 & 1 \\ 0 & 0 & 1 & 0 \\ 0 & 1 & 0 & 0 \\ 1 & 0 & 0 & 0\end{matrix} ] \qquad [ 16 ]$$

Case 3 is a case where the polarity of the analog signal A_{YQ} is inverted as compared with case 1. This is relevant to, for example, a case where connection from the 2×2 optical coupler 115D of the reception unit 10 to the PDs 131 and 132 of the photoelectric converter 13D is reversed. In this case, the transfer matrix T_{RF} is expressed by the following equation.

$${T}_{RF} = [ \begin{matrix}1 & 0 & 0 & 0 \\ 0 & 1 & 0 & 0 \\ 0 & 0 & 1 & 0 \\ 0 & 0 & 0 & - 1\end{matrix} ] \qquad [ 17 ]$$

Case 4 is a case where connection between the reception unit 10 and the drivers 29A and 29B is reversed as compared with case 1. In this case, the transfer matrix T_{RF} is expressed by the following equation.

$${T}_{RF} = [ \begin{matrix}0 & 1 & 0 & 0 \\ 1 & 0 & 0 & 0 \\ 0 & 0 & 1 & 0 \\ 0 & 0 & 0 & 1\end{matrix} ] \qquad [ 18 ]$$

As described above, parameters of the transfer matrix T_{RF} vary depending on the design of the wavelength converter. Therefore, a method capable of making the polarization axis of the I component and the polarization axis of the Q component coincide with each other without depending on the parameters of the transfer matrix T_{RF} is required.

On the other hand, in this configuration, the polarization axis of the I component can coincide with the polarization axis of the Q component in the output optical signal OUT by adjusting the bias points of the MZ optical modulators 24A to 24D and the phase modulators 25A and 25B of the transmission unit 20. Hereinafter, a mechanism in the wavelength converter 100 relevant to case 1 will be described.

The transfer matrix T_{MZ} by the intensity modulation of the light L_{T} in the MZ optical modulators 24A to 24D and the phase modulation in the phase modulators 25A and 25B is expressed by the following equation.

$${T}_{MZ} = [ \begin{matrix}{S}_{MZ , XI} & 0 & 0 & 0 \\ 0 & {S}_{MZ , XQ} {S}_{MZ , XP} & 0 & 0 \\ 0 & 0 & {S}_{MZ , YI} & 0 \\ 0 & 0 & 0 & {S}_{MZ , YQ} {S}_{MZ , YP}\end{matrix} ] \qquad [ 19 ]$$

In Equation [19], S_{MZ,XI}, S_{MZ,XQ}, S_{MZ,YI}, and S_{MZ,YQ} are parameters according to the intensity modulation in the MZ optical modulators 24A to 24D, respectively. S_{MZ,XP} and S_{MZ,YP} are parameters according to the phase modulation in the phase modulators 25A and 25B, respectively. Values of these parameters can be controlled by adjusting the bias points of the MZ optical modulators 24A to 24D and the phase modulators 25A and 25B.

At this time, Equation [14] can be rewritten as follows.

$$[ \begin{matrix}{S}_{MZ , XI} & 0 & 0 & 0 \\ 0 & {S}_{MZ , XQ} {S}_{MZ , XP} & 0 & 0 \\ 0 & 0 & {S}_{MZ , YI} & 0 \\ 0 & 0 & 0 & {S}_{MZ , YQ} {S}_{MZ , YP}\end{matrix} ] {T}_{RF} {T}_{R} = AP ( {Δϕ}_{X} , {Δϕ}_{Y} ) R ( {Δθ}_{0} ) [ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] {T}_{R} \qquad [ 20 ]$$

The polarization axis of the I component can coincide with the polarization axis of the Q component in the output optical signal OUT by adjusting the bias points of the MZ optical modulators 24A to 24D and the phase modulators 25A and 25B of the transmission unit 20 in such a way as to satisfy Equation [20].

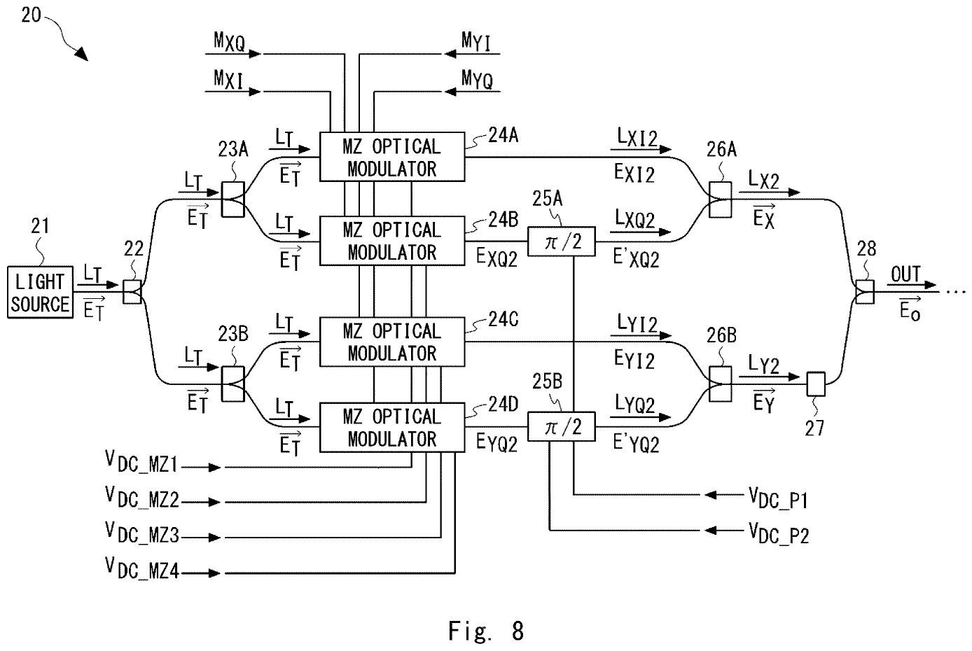

Adjustment of the bias points will be described. FIG. 8 is a diagram illustrating a definition of an electric field of an optical signal in each unit of the transmission unit 20. A complex electric field vector E_{T} of the transmission light L_{T} input to the MZ optical modulators 24A to 24D is expressed by the following equation.

\vec{E_{T}}=e^{jω}^{_{O}}^{t} [symbol] [21]

Here, a complex amplitude of a complex electric field of the transmission light L_{T} input to the MZ optical modulators 24A to 24D is 1. Complex amplitudes of electric fields of the XI optical signal L_{XI2}, the XQ optical signal L_{XQ2}, the YI optical signal L_{YI2}, and the YQ optical signal L_{YQ2} output from the MZ optical modulators 24A to 24D are E_{XI2}, E_{XQ2}, E_{YI2}, and E_{YQ2}, respectively. A complex amplitude of an electric field of an optical signal obtained by phase-modulating the XQ optical signal L_{XQ2} by the phase modulator 25A is E′_{XQ2}. A complex amplitude of an electric field of an optical signal obtained by phase-modulating the YQ optical signal L_{YQ2} by the phase modulator 25B is E′_{YQ2}. A complex amplitude of an electric field of the X-polarized wave optical signal L_{X2} multiplexed by the 2×1 optical coupler 26A is defined as EX. A complex amplitude of an electric field of the Y-polarized wave optical signal L_{Y2} multiplexed by the 2×1 optical coupler 26B is defined as E_{Y}. In FIG. 8, the modulation signals applied to the MZ optical modulators 24A to 24D are indicated by M_{XI}, M_{XQ}, M_{YI}, and M_{YQ}, respectively. The DC bias voltages applied to the MZ optical modulators 24A to 24D are indicated as V_{DC_MZ1} to V_{DC_MZ4}. The DC bias voltages applied to the phase modulators 25A and 25B are indicated as V_{DC_P1} and V_{DC_P2}. Hereinafter, the DC bias voltage is simply referred to as a bias voltage.

At this time, if each bias voltage is set to a bias point necessary for coherent modulation, the complex amplitude vector Eₒ of the electric field of the output optical signal OUT is expressed by the following equation.

$$\vec{{E}_{o}} = \frac{π}{{V}_{π}} ( ( \pm {V}_{XI} ( t ) \pm ( \pm j ) {V}_{XQ} ( t ) ) \text{?} + ( \pm {V}_{YI} ( t ) \pm ( \pm j ) {V}_{YQ} ( t ) ) \text{?} ) \qquad [ 22 ]$$

Here, V_{XI}(t), V_{XQ}(t), V_{YI}(t), and V_{YQ}(t) are voltages of the modulation signals M_{XI}, M_{XQ}, M_{YI}, and M_{YQ} applied to analog signal electrodes of the MZ optical modulators 24A to 24D, respectively.

Among them, the signs before and after V_{XI}(t) and V_{YI}(t) are determined by the values of the bias voltages applied to MZ optical modulators 24A to 24D, that is, the bias points. The sign immediately before the imaginary unit j is determined at the bias points of the phase modulators 25A and 25B. The bias point required in the coherent modulation is a bias voltage at a so-called null point at which a complex electric field of an output optical signal of an intensity modulator becomes 0 in a case where there is no modulation signal input to the intensity modulator, and a bias voltage at a so-called orthogonal point at which the phase modulator applies a phase shift of ±90°.

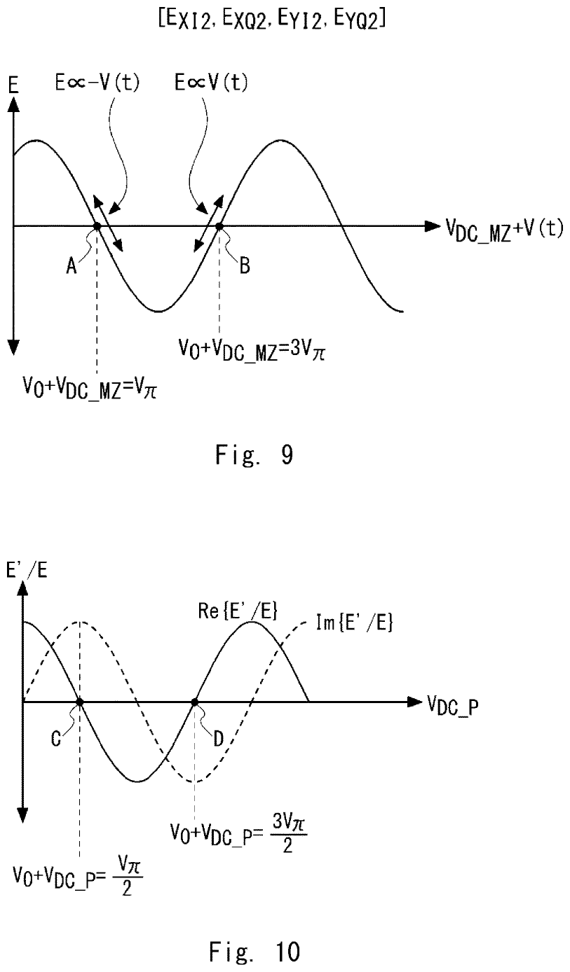

The adjustment of the bias points of the MZ optical modulators 24A to 24D will be described. FIG. 9 is a diagram illustrating a relationship between the bias point of the MZ optical modulator 24A and the electric field of the optical signal. In FIG. 9, the voltages of the modulation signals M_{XI}, M_{XQ}, M_{YI}, and M_{YQ} respectively applied to the MZ optical modulators 24A to 24D are indicated as V(t). The bias voltage applied to each of the MZ optical modulators 24A to 24D is indicated as V_{DC_MZ}. Here, V₀ is a constant according to a modulator device characteristic referred to as an offset voltage. The complex amplitude E of the electric field of the optical signal output from the MZ optical modulators 24A to 24D changes in a sinusoidal shape in accordance with the voltage of the modulation signal. In addition, the operating points of the MZ optical modulators 24A to 24D can be adjusted by the bias voltage V_{DC_MZ}.

In the MZ optical modulators 24A to 24D, the phase shift amount of the optical signal after the intensity modulation is 180° at the time in which the optical signal is biased to a null point A where a change rate of the complex amplitude E of the electric field is negative with respect to the voltage of the applied modulation signal. In this case, the parameter S_{MZ,XI} of Equations [19] and [20] is −1.

On the other hand, in the MZ optical modulators 24A to 24D, the phase shift amount of the optical signal after the intensity modulation is 0° at the time in which the optical signal is biased to a null point B where the change rate of the complex amplitude E of the electric field is positive with respect to the voltage of the applied modulation signal. In this case, the parameter S_{MZ,XI} of Equations [19] and [20] is +1.

Therefore, by adjusting the bias points of the MZ optical modulators 24A to 24D by the bias voltage V_{DC_MZ}, each of the parameters S_{MZ,XI}, S_{MZ,XQ}, S_{MZ,YI}, and S_{MZ,YQ} can be set to −1 or +1.

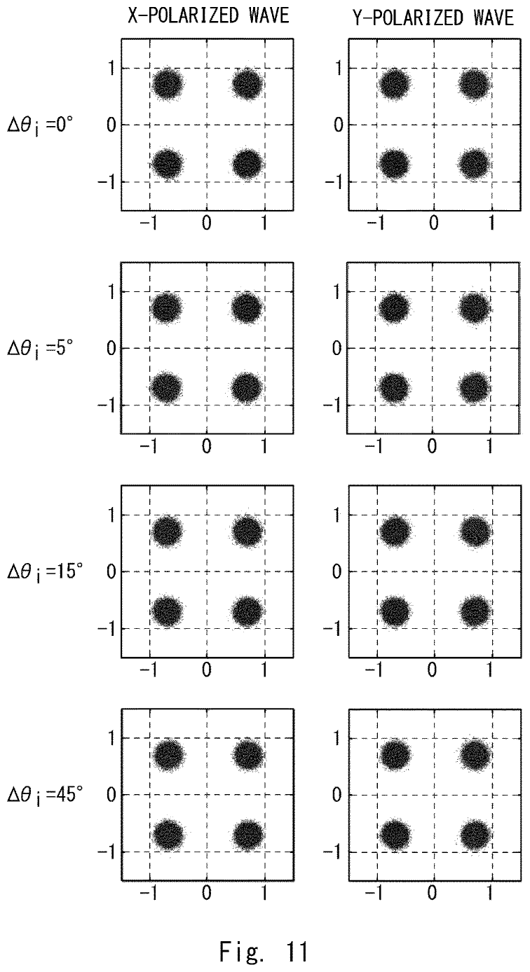

Next, the adjustment of the bias points of the phase modulators 25A and 25B will be described. FIG. 10 is a diagram illustrating a relationship between the bias points of the phase modulators 25A and 25B and the complex amplitudes of the electric fields of optical signals. A ratio between the complex amplitude E′ of the electric field of the optical signal output from the phase modulator and the complex amplitude E of the electric field of the optical signal input to the phase modulator changes in a complex sinusoidal shape in accordance with the bias voltage V_{DC_P}. A ratio between the complex amplitude E′ of the electric field of the optical signal output from the phase modulator and the complex amplitude E of the electric field of the optical signal input to the phase modulator is expressed by the following equation.

$$\frac{{E}^{′}}{E} = {e}^{\frac{j π ( {V}_{0} + {V}_{DC \_ P} )}{{V}_{π}}} \qquad [ 23 ]$$

Therefore, a ratio or a phase difference between the complex amplitude E′ of the electric field of the optical signal output from the phase modulator and the complex amplitude E of the electric field of the optical signal input to the phase modulator can be adjusted by the bias voltage V_{DC_P}.

E_{XQ2} and E_{YQ2} of the XQ optical signal L_{XQ2} and the YQ optical signal L_{YQ2} input to each of the phase modulators 25A and 25B are relevant to the complex amplitude E of the electric field. The complex amplitudes E_{XQ2} and E_{YQ2} of the electric field of the optical signal output from each of the phase modulators 25A and 25B are relevant to the complex amplitude E′ of the electric field. In a case where a phase shift of ±90° is applied to each of the XQ optical signal L_{XQ2} and the YQ optical signal L_{YQ2} by the phase modulators 25A and 25B, the ratio of the complex amplitude E′ of the electric field to the complex amplitude E of the electric field becomes j. Therefore, the complex amplitudes E′_{XQ2} and E′_{YQ2} of the electric fields of the XQ optical signal L_{XQ2} and the YQ optical signal L_{YQ2} after the phase shift are ±jE_{XQ2} and ±j_{EYQ2}, respectively.

In FIG. 10, at an orthogonal point C at which the complex component Im(E′/E) is maximized, the parameters S_{MZ,XP} and S_{MZ,YP} of the relevant Equations [19] and [20] are +1. At this time, the phase difference of the Q component with respect to the I component is +90°. At an orthogonal point D at which the complex component Im(E′/E) is minimized, the parameters S_{MZ,XP} and S_{MZ,YP} of Equations [19] and [20] are −1. At this time, the phase difference of the Q component with respect to the I component is −90° (+270°).

Therefore, by adjusting the operating points of the phase modulators 25A and 25B by the bias voltage V_{DC_P}, each of the parameters S_{MZ,XP} and S_{MZ,YP} can be set to −1 or +1.

As described above, in the present configuration, the parameters of the transfer matrix T_{M}Z of Equations [19] and [20] can be set to −1 or +1 by setting the bias voltage provided to the MZ optical modulators and the phase modulators in the transmission unit 20.

As a result, in the transfer matrix T_{MZ}, S_{MZ,XI} can be set to S_{X}, S_{MZ,XQ}S_{MZ,XP} can be set to ±Sₓ, S_{MZ,YI} can be set to S_{Y}, and S_{MZ,YQ}S_{MZ,YP} can be set to ±S_{y}. Hereinafter, specific examples thereof will be described by mathematical equations.

$$[ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] = [ \begin{matrix}1 & 0 & 0 & 0 \\ 0 & 1 & 0 & 0 \\ 0 & 0 & 1 & 0 \\ 0 & 0 & 0 & 1\end{matrix} ] \qquad [ 24 ]$$

$$[ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] = [ \begin{matrix}1 & 0 & 0 & 0 \\ 0 & - 1 & 0 & 0 \\ 0 & 0 & - 1 & 0 \\ 0 & 0 & 0 & - 1\end{matrix} ] \qquad [ 25 ]$$

$$[ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] = [ \begin{matrix}- 1 & 0 & 0 & 0 \\ 0 & - 1 & 0 & 0 \\ 0 & 0 & - 1 & 0 \\ 0 & 0 & 0 & - 1\end{matrix} ] \qquad [ 26 ]$$

$$[ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] = [ \begin{matrix}- 1 & 0 & 0 & 0 \\ 0 & 1 & 0 & 0 \\ 0 & 0 & - 1 & 0 \\ 0 & 0 & 0 & 1\end{matrix} ] \qquad [ 27 ]$$

As a result, according to this configuration, as illustrated in FIG. 6, although the influence of the deviation Δθᵢ of the polarization axis of the coherent detection with respect to the polarization axis of the input optical signal IN remains, the polarization axis of the I component can be caused to coincide with the polarization axis of the Q component.

FIG. 11 is a diagram illustrating a constellation of the output optical signal OUT after wavelength conversion by the wavelength converter according to the example embodiment. In the wavelength converter 100, as illustrated in FIG. 11, even if there is a deviation of the polarization axis of the coherent detection with respect to the polarization axis of the input optical signal IN, it can be seen that the signal quality can be maintained by suitably adjusting the bias points of the MZ optical modulators 24A to 24D and the phase modulators 25A and 25B.

Note that, also in cases 2 to 4 of FIG. 7, similarly, by satisfying Equation [20], the polarization axis of the I component and the polarization axis of the Q component in the output optical signal OUT can be caused to coincide with each other.

In case 2, the transfer matrix T_{WC} is expressed by the following equation.

$${T}_{WC} = {T}_{MZ} {T}_{RF} {T}_{R} = {T}_{MZ} [ \begin{matrix}0 & 0 & 0 & 1 \\ 0 & 0 & 1 & 0 \\ 0 & 1 & 0 & 0 \\ 1 & 0 & 0 & 0\end{matrix} ] {T}_{R} = [ \begin{matrix}0 & 0 & 0 & {S}_{MZ , XI} \\ 0 & 0 & {S}_{MZ , XQ} {S}_{MZ , XP} & 0 \\ 0 & {S}_{MZ , YI} & 0 & 0 \\ {S}_{MZ , YQ} {S}_{MZ , YP} & 0 & 0 & 0\end{matrix} ] {T}_{R} = P ( \frac{π}{2} , \frac{π}{2} ) R ( \frac{π}{2} ) [ \begin{matrix}{S}_{MZ , YQ} {S}_{MZ , YP} & 0 & 0 & 0 \\ 0 & {S}_{MZ , YI} & 0 & 0 \\ 0 & 0 & {S}_{MZ , XQ} {S}_{MZ , XP} & 0 \\ 0 & 0 & 0 & {S}_{MZ , XI}\end{matrix} ] {T}_{R} \qquad [ 28 ]$$

Therefore, in this case, the bias points of the MZ optical modulators 24A to 24D and the phase modulators 25A and 25B may be adjusted in such a way as to simultaneously satisfy the relationship expressed by the following equations.

S_{MZ,XI}=±S_{MZ,XQ}S_{MZ,XP} [29]

S_{MZ,YI}=±S_{MZ,YQ}S_{MZ,YP} [30]

In case 3, the transfer matrix T_{WC} is expressed by the following equation.

$${T}_{WC} = {T}_{MZ} {T}_{RF} {T}_{R} = {T}_{MZ} [ \begin{matrix}1 & 0 & 0 & 0 \\ 0 & 1 & 0 & 0 \\ 0 & 0 & 1 & 0 \\ 0 & 0 & 0 & - 1\end{matrix} ] {T}_{R} = [ \begin{matrix}{S}_{MZ , XI} & 0 & 0 & 0 \\ 0 & {S}_{MZ , XQ} {S}_{MZ , XP} & 0 & 0 \\ 0 & 0 & {S}_{MZ , YI} & 0 \\ 0 & 0 & 0 & - {S}_{MZ , YQ} {S}_{MZ , YP}\end{matrix} ] {T}_{R} \qquad [ 31 ]$$

Therefore, in this case, the bias points of the MZ optical modulators 24A to 24D and the phase modulators 25A and 25B may be adjusted in such a way as to simultaneously satisfy the relationship expressed by the following equations.

S_{MZ,XI}=±S_{MZ,XQ}S_{MZ,XP} [32]

S_{MZ,YI}=∓S_{MZ,YQ}S_{MZ,YP} [33]

In case 4, the transfer matrix T_{WC} is expressed by the following equation.

$${T}_{WC} = {T}_{MZ} {T}_{RF} {T}_{R} = {T}_{MZ} [ \begin{matrix}0 & 1 & 0 & 0 \\ 1 & 0 & 0 & 0 \\ 0 & 0 & 1 & 0 \\ 0 & 0 & 0 & 1\end{matrix} ] {T}_{R} = [ \begin{matrix}0 & {S}_{MZ , XI} & 0 & 0 \\ {S}_{MZ , XQ} {S}_{MZ , XP} & 0 & 0 & 0 \\ 0 & 0 & {S}_{MZ , YI} & 0 \\ 0 & 0 & 0 & {S}_{MZ , YQ} {S}_{MZ , YP}\end{matrix} ] {T}_{R} = P ( \frac{π}{2} , 0 ) [ \begin{matrix}- {S}_{MZ , XQ} {S}_{MZ , XP} & 0 & 0 & 0 \\ 0 & {S}_{MZ , XI} & 0 & 0 \\ 0 & 0 & {S}_{MZ , YI} & 0 \\ 0 & 0 & 0 & {S}_{MZ , YQ} {S}_{MZ , YP}\end{matrix} ] {T}_{R} \qquad [ 34 ]$$

Therefore, in this case, the bias points of the MZ optical modulators 24A to 24D and the phase modulators 25A and 25B may be adjusted in such a way as to simultaneously satisfy the relationship expressed by the following equations.

S_{MZ,XI}=∓S_{MZ,XQ}S_{MZ,XP} [35]

S_{MZ,YI}=±S_{MZ,YQ}S_{MZ,YP} [36]

As described above, according to the present configuration, in the wavelength converter of the OAO system, it is possible to prevent the influence of the mixture of the projections of both polarization components in the analog signal due to wavelength conversion on the signal quality. As a result, it is possible to maintain the orthogonal states of XI, XQ, YI, and YQ in the output optical signal OUT and maintain the quality as the DP-QPSK signal.

Note that, in the wavelength converter 100, the operating points of the MZ optical modulators and the phase modulators may fluctuate due to the influence of temperature change or the like while being mounted and operated in the optical network. If the operating points fluctuate, as illustrated in FIG. 6, a situation in which the wavelength conversion of the DP-QPSK optical signal is not able to be normally performed may occur. On the other hand, according to the wavelength converter 100 of the present example embodiment, even if the operating points of the MZ optical modulators 24A to 24D and the phase modulators 25A and 25B fluctuate due to environmental factors, the fluctuation of the operating points can easily be compensated by adjusting the bias points. As a result, stable wavelength conversion can be realized regardless of the environmental factors.

### OTHER EXAMPLE EMBODIMENTS

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the above-described example embodiment, the configuration in which the analog signals A_{XI}, A_{XQ}, A_{YI}, and A_{YQ} are transmitted from the reception unit 10 to the transmission unit 20 has been described, but this is merely an example. For example, an analog compensation unit may be inserted between the reception unit 10 and the transmission unit 20 in order to perform some or all of amplitude compensation, phase compensation, offset compensation, distortion compensation, and noise removal of the analog signals A_{XI}, A_{XQ}, A_{YI}, and A_{YQ}. In addition, the drivers 29A to 29D of the transmission unit 20 may be incorporated in an analog compensation unit.

Each of the drawings is merely an example to illustrate one or a plurality of example embodiments. Each drawing is not associated with only one specific example embodiment, but may be associated with one or more other example embodiments. As those of ordinary skill in the art will appreciate, various features or steps described with reference to any one of the drawings may be combined with features or steps illustrated in one or more other drawings, for example, to create an example embodiment that is not explicitly illustrated nor described. All of the features or steps illustrated in any one of the drawings for describing exemplary example embodiments are not necessarily mandatory, and some features or steps may be omitted. The order of the steps described in any of the drawings may be changed as appropriate.

In the above description of the example embodiment, the wavelength conversion of the DP-QPSK-modulated optical signal has been described, but this is merely an example. The wavelength converter according to the above-described example embodiment may also be applied to the wavelength conversion of the optical signal modulated based on various coherent modulation schemes different from DP-QPSK modulation.

Some or all of the example embodiments described above may also be described as, but are not limited to, the following Supplementary Notes.

### (Supplementary Note 1)

A wavelength converter according to one aspect of the present disclosure including:
a reception means for receiving an input optical signal of a first wavelength, which is polarization-multiplexed and quadrature-phase-modulated, and demodulating the input optical signal into an in-phase analog signal and a quadrature-phase analog signal relevant to a first polarization, and an in-phase analog signal and a quadrature-phase analog signal relevant to a second polarization; and
a transmission means for transmitting an output optical signal of a second wavelength different from the first wavelength, which is polarization-multiplexed and quadrature-phase-modulated, and which is obtained by multiplexing an in-phase optical signal of the first polarization obtained by intensity-modulating light of the second wavelength based on the in-phase analog signal relevant to the first polarization, a quadrature-phase optical signal of the first polarization obtained by intensity-modulating the light of the second wavelength based on the quadrature-phase analog signal relevant to the first polarization, an in-phase optical signal of the second polarization obtained by intensity-modulating the light of the second wavelength based on the in-phase analog signal relevant to the second polarization, and a quadrature-phase optical signal of the second polarization obtained by intensity-modulating the light of the second wavelength based on the quadrature-phase analog signal relevant to the second polarization,
wherein, in the output optical signal, a phase relationship between a component of the in-phase analog signal and a component of the quadrature-phase analog signal relevant to the first polarization and a phase relationship between a component of the in-phase analog signal and a component of the quadrature-phase analog signal relevant to the second polarization are maintained in the same phase relationship.

### (Supplementary Note 2)

The wavelength converter according to Supplementary Note 1, wherein the transmission means performs intensity modulation and multiplexing of the in-phase optical signal and the quadrature-phase optical signal of the first polarization and the in-phase optical signal and the quadrature-phase optical signal of the second polarization in such a way that, in the output optical signal, the phase relationship between the component of the in-phase analog signal and the component of the quadrature-phase analog signal relevant to the first polarization and the phase relationship between the component of the in-phase analog signal and the component of the quadrature-phase analog signal relevant to the second polarization are the same phase relationship.

### (Supplementary Note 3)

The wavelength converter according to Supplementary Note 1 or 2, wherein
the transmission means includes
a drive means for outputting first and second modulation signals based on the in-phase analog signal and the quadrature-phase analog signal relevant to the first polarization, and third and fourth modulation signals based on the in-phase analog signal and the quadrature-phase analog signal relevant to the second polarization, respectively;
first to fourth optical modulators that output optical signals obtained by intensity-modulating light of the second wavelength in accordance with the first to fourth modulation signals, respectively;
a first phase modulator that performs phase modulation in such a way that the optical signal intensity-modulated by the second optical modulator has a quadrature phase with respect to the optical signal intensity-modulated by the first optical modulator;
a second phase modulator that performs phase modulation in such a way that the optical signal intensity-modulated by the fourth optical modulator has a quadrature phase with respect to the optical signal intensity-modulated by the third optical modulator;
an optical modulator bias means for outputting first to fourth bias voltages for controlling operating points of the first to fourth optical modulators to the first to fourth optical modulators, respectively; and
a phase modulator bias means for outputting fifth and sixth bias voltages for controlling operating points of the first and second phase modulators to the first and second phase modulators, respectively, and
the optical modulator bias means sets the respective operating points of the first to fourth optical modulators by the first to fourth bias voltages and the phase modulator bias means sets the respective operating points of the first and second phase modulators by the fifth and sixth bias voltages in such a way that, in the output optical signal, the phase relationship between the component of the in-phase analog signal and the component of the quadrature-phase analog signal relevant to the first polarization and the phase relationship between the component of the in-phase analog signal and the component of the quadrature-phase analog signal relevant to the second polarization are the same phase relationship.

### (Supplementary Note 4)

The wavelength converter according to Supplementary Note 3, wherein
the optical modulator bias means sets, in each of the first to fourth optical modulators, the first to fourth bias voltages in such a way that a phase shift after intensity modulation of light of the second wavelength is 0° or the phase shift after the intensity modulation of the light of the second wavelength is 180°, and
the phase modulator bias means sets the fifth bias voltage in such a way that a phase of the optical signal intensity-modulated by the second optical modulator becomes +90° or −90° with respect to a phase of the optical signal intensity-modulated by the first optical modulator, and sets the sixth bias voltage in such a way that a phase of the optical signal intensity-modulated by the fourth optical modulator becomes +90° or −90° with respect to a phase of the optical signal intensity-modulated by the third optical modulator.

### (Supplementary Note 5)

The wavelength converter according to Supplementary Note 3, wherein
a complex amplitude vector Eₒ of an electric field of the output optical signal is expressed by the following equation by a complex amplitude vector Eᵢ of an electric field of the input optical signal and a transfer matrix T_{WC} representing wavelength conversion by the wavelength converter,

\vec{E_{O}}=T_{WC}\vec{Eᵢ} [37]
the transfer matrix T_{WC} is expressed by the following equation by Δθᵢ representing an angle formed by a polarization axis of the input optical signal and a polarization axis of coherent detection performed by the reception means to receive the input optical signal, a transfer matrix T_{RF} by the drive means and transmission of the in-phase analog signal and the quadrature-phase analog signal relevant to the first polarization and the in-phase analog signal and the quadrature-phase analog signal relevant to the second polarization from the reception means to the drive means, a transfer matrix T_{MZ} by the first to fourth optical modulators and the first and second phase modulators, a matrix P(Δφₓ, Δφ_{y}) by a phase shift in wavelength conversion in the wavelength converter, and a matrix R(Δθ₀) by polarization rotation in wavelength conversion in the wavelength converter,

$${T}_{WC} = {T}_{MZ} {T}_{RF} {T}_{R} = P ( {Δϕ}_{X} , {Δϕ}_{Y} ) R ( {Δθ}_{0} ) [ \begin{matrix}{S}_{MZ , XI} & 0 & 0 & 0 \\ 0 & {S}_{MZ , XQ} {S}_{MZ , XP} & 0 & 0 \\ 0 & 0 & {S}_{MZ , YI} & 0 \\ 0 & 0 & 0 & {S}_{MZ , YQ} {S}_{MZ , YP}\end{matrix} ] {T}_{R} \qquad [ 38 ]$$

S_{MZ,XI}=1 is established if the first bias voltage is set in such a way that a phase shift after intensity modulation of light of the second wavelength becomes 0°, and S_{MZ,XI}=−1 is established if the first bias voltage is set in such a way that the phase shift after the intensity modulation of the light of the second wavelength becomes 180°,
S_{MZ,XQ}=1 is established if the second bias voltage is set in such a way that the phase shift after the intensity modulation of the light of the second wavelength becomes 0°, and S_{MZ,XQ}=−1 is established if the second bias voltage is set in such a way that the phase shift after the intensity modulation of the light of the second wavelength becomes 180°,
S_{MZ,XP}=1 is established if the fifth bias voltage is set in such a way that the phase of the optical signal intensity-modulated by the second optical modulator becomes +90° with respect to the phase of the optical signal intensity-modulated by the first optical modulator, and S_{MZ,XP}=−1 is established if the fifth bias voltage is set in such a way that the phase of the optical signal intensity-modulated by the second optical modulator becomes −90° with respect to the phase of the optical signal intensity-modulated by the first optical modulator,
S_{MZ,YI}=1 is established if the third bias voltage is set in such a way that the phase shift after the intensity modulation of the light of the second wavelength becomes 0°, and S_{MZ,YI}=−1 is established if the third bias voltage is set in such a way that the phase shift after the intensity modulation of the light of the second wavelength becomes 180°,
S_{MZ,YQ}=1 is established if the fourth bias voltage is set in such a way that the phase shift after the intensity modulation of the light of the second wavelength becomes 0°, and S_{MZ,YQ}=−1 is established if the fourth bias voltage is set in such a way that the phase shift after the intensity modulation of the light of the second wavelength becomes 180°,
S_{MZ,YP}=1 is established if the sixth bias voltage is set in such a way that the phase of the optical signal intensity-modulated by the fourth optical modulator becomes +90° with respect to the phase of the optical signal intensity-modulated by the third optical modulator, and S_{MZ,YP}=−1 is established if the sixth bias voltage is set in such a way that the phase of the optical signal intensity-modulated by the fourth optical modulator becomes −90° with respect to the phase of the optical signal intensity-modulated by the third optical modulator, and
the optical modulator bias means sets operating points of the respective first to fourth optical modulators by the first to fourth bias voltages, and the phase modulator bias means sets operating points of the respective first and second phase modulators by the fifth and sixth bias voltages in such a way that the following equation is established if a value of S_{MZ,YI} is set to S_{X} and a value of S_{MZ,YI} is set to S_{Y}.

$$[ \begin{matrix}{S}_{MZ , XI} & 0 & 0 & 0 \\ 0 & {S}_{MZ , XQ} {S}_{MZ , XP} & 0 & 0 \\ 0 & 0 & {S}_{MZ , YI} & 0 \\ 0 & 0 & 0 & {S}_{MZ , YQ} {S}_{MZ , YP}\end{matrix} ] {T}_{RF} {T}_{R} = AP ( {Δϕ}_{X} , {Δϕ}_{Y} ) R ( {Δθ}_{0} ) [ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] {T}_{R} \qquad [ 39 ]$$

### (Supplementary Note 6)

A wavelength conversion method including:
receiving an input optical signal of a first wavelength, which is polarization-multiplexed and quadrature-phase-modulated, and demodulating the input optical signal into an in-phase analog signal and a quadrature-phase analog signal relevant to a first polarization, and an in-phase analog signal and a quadrature-phase analog signal relevant to a second polarization; and
transmitting an output optical signal of a second wavelength different from the first wavelength, which is polarization-multiplexed and quadrature-phase-modulated, and which is obtained by multiplexing an in-phase optical signal of the first polarization obtained by intensity-modulating light of the second wavelength based on the in-phase analog signal relevant to the first polarization, a quadrature-phase optical signal of the first polarization obtained by intensity-modulating the light of the second wavelength based on the quadrature-phase analog signal relevant to the first polarization, an in-phase optical signal of the second polarization obtained by intensity-modulating the light of the second wavelength based on the in-phase analog signal relevant to the second polarization, and a quadrature-phase optical signal of the second polarization obtained by intensity-modulating the light of the second wavelength based on the quadrature-phase analog signal relevant to the second polarization,
wherein, in the transmission of the output optical signal, intensity modulation and multiplexing of the in-phase optical signal and the quadrature-phase optical signal of the first polarization and the in-phase optical signal and the quadrature-phase optical signal of the second polarization are performed in such a way that, in the output optical signal, a phase relationship between a component of the in-phase analog signal and a component of the quadrature-phase analog signal and relevant to the first polarization and a phase relationship between a component of the in-phase analog signal and a component of the quadrature-phase analog signal relevant to the second polarization are the same phase relationship.

Some or all of the elements (for examples, configurations and functions) described in Supplementary Notes 2 to 5 dependent on Supplementary Note 1 may also be dependent on Supplementary Note 6 with dependency relationships similar to those of Supplementary Notes 2 to 5. Some or all of the elements described in any Supplementary Note can be applied to various types of hardware, software, and recording means for recording software, systems, and methods.

What is claimed is:

1. A wavelength converter comprising:
a reception unit configured to receive an input optical signal of a first wavelength, which is polarization-multiplexed and quadrature-phase-modulated, and demodulate the input optical signal into an in-phase analog signal and a quadrature-phase analog signal relevant to a first polarization, and an in-phase analog signal and a quadrature-phase analog signal relevant to a second polarization; and
a transmission unit configured to transmit an output optical signal of a second wavelength different from the first wavelength, which is polarization-multiplexed and quadrature-phase-modulated, and which is obtained by multiplexing an in-phase optical signal of the first polarization obtained by intensity-modulating light of the second wavelength based on the in-phase analog signal relevant to the first polarization, a quadrature-phase optical signal of the first polarization obtained by intensity-modulating the light of the second wavelength based on the quadrature-phase analog signal relevant to the first polarization, an in-phase optical signal of the second polarization obtained by intensity-modulating the light of the second wavelength based on the in-phase analog signal relevant to the second polarization, and a quadrature-phase optical signal of the second polarization obtained by intensity-modulating the light of the second wavelength based on the quadrature-phase analog signal relevant to the second polarization,
wherein, in the output optical signal, a phase relationship between a component of the in-phase analog signal and a component of the quadrature-phase analog signal relevant to the first polarization and a phase relationship between a component of the in-phase analog signal and a component of the quadrature-phase analog signal relevant to the second polarization are maintained in the same phase relationship.

2. The wavelength converter according to claim 1, wherein the transmission unit performs intensity modulation and multiplexing of the in-phase optical signal and the quadrature-phase optical signal of the first polarization and the in-phase optical signal and the quadrature-phase optical signal of the second polarization in such a way that, in the output optical signal, the phase relationship between the component of the in-phase analog signal and the component of the quadrature-phase analog signal relevant to the first polarization and the phase relationship between the component of the in-phase analog signal and the component of the quadrature-phase analog signal relevant to the second polarization are the same phase relationship.

3. The wavelength converter according to claim 1, wherein
the transmission unit comprises
a drive unit configured to output first and second modulation signals based on the in-phase analog signal and the quadrature-phase analog signal relevant to the first polarization, and third and fourth modulation signals based on the in-phase analog signal and the quadrature-phase analog signal relevant to the second polarization, respectively;
first to fourth optical modulators configured to output optical signals obtained by intensity-modulating light of the second wavelength in accordance with the first to fourth modulation signals, respectively;
a first phase modulator configured to perform phase modulation in such a way that the optical signal intensity-modulated by the second optical modulator has a quadrature phase with respect to the optical signal intensity-modulated by the first optical modulator;
a second phase modulator configured to perform phase modulation in such a way that the optical signal intensity-modulated by the fourth optical modulator has a quadrature phase with respect to the optical signal intensity-modulated by the third optical modulator;
an optical modulator bias unit configured to output first to fourth bias voltages for controlling operating points of the first to fourth optical modulators to the first to fourth optical modulators, respectively; and
a phase modulator bias unit configured to output fifth and sixth bias voltages for controlling operating points of the first and second phase modulators to the first and second phase modulators, respectively, and
the optical modulator bias unit sets the respective operating points of the first to fourth optical modulators by the first to fourth bias voltages and the phase modulator bias unit sets the respective operating points of the first and second phase modulators by the fifth and sixth bias voltages in such a way that, in the output optical signal, the phase relationship between the component of the in-phase analog signal and the component of the quadrature-phase analog signal relevant to the first polarization and the phase relationship between the component of the in-phase analog signal and the component of the quadrature-phase analog signal relevant to the second polarization are the same phase relationship.

4. The wavelength converter according to claim 3, wherein
the optical modulator bias unit sets, in each of the first to fourth optical modulators, the first to fourth bias voltages in such a way that a phase shift after intensity modulation of light of the second wavelength is 0° or the phase shift after the intensity modulation of the light of the second wavelength is 180°, and
the phase modulator bias unit sets the fifth bias voltage in such a way that a phase of the optical signal intensity-modulated by the second optical modulator becomes +90° or −90° with respect to a phase of the optical signal intensity-modulated by the first optical modulator, and sets the sixth bias voltage in such a way that a phase of the optical signal intensity-modulated by the fourth optical modulator becomes +90° or −90° with respect to a phase of the optical signal intensity-modulated by the third optical modulator.

5. The wavelength converter according to claim 3, wherein
a complex amplitude vector Eₒ of an electric field of the output optical signal is expressed by the following equation by a complex amplitude vector Eᵢ of an electric field of the input optical signal and a transfer matrix T_{WC} representing wavelength conversion by the wavelength converter,
\vec{E_{O}}=T_{WC}\vec{Eᵢ} [1]
the transfer matrix T_{WC} is expressed by the following equation by Δθᵢ representing an angle formed by a polarization axis of the input optical signal and a polarization axis of coherent detection performed by the reception unit to receive the input optical signal, a transfer matrix T_{RF} by the drive unit and transmission of the in-phase analog signal and the quadrature-phase analog signal relevant to the first polarization and the in-phase analog signal and the quadrature-phase analog signal relevant to the second polarization from the reception unit to the drive unit, a transfer matrix T_{MZ} by the first to fourth optical modulators and the first and second phase modulators, a matrix P(Δφₓ, Δφ_{y}) by a phase shift in wavelength conversion in the wavelength converter, and a matrix R(Δθ₀) by polarization rotation in wavelength conversion in the wavelength converter,
$${T}_{WC} = {T}_{MZ} {T}_{RF} {T}_{R} = P ( {Δϕ}_{X} , {Δϕ}_{Y} ) R ( {Δθ}_{0} ) [ \begin{matrix}{S}_{MZ , XI} & 0 & 0 & 0 \\ 0 & {S}_{MZ , XQ} {S}_{MZ , XP} & 0 & 0 \\ 0 & 0 & {S}_{MZ , YI} & 0 \\ 0 & 0 & 0 & {S}_{MZ , YQ} {S}_{MZ , YP}\end{matrix} ] {T}_{R} \qquad [ 2 ]$$
S_{MZ,XI}=1 is established if the first bias voltage is set in such a way that a phase shift after intensity modulation of light of the second wavelength becomes 0°, and S_{MZ,XI}=−1 is established if the first bias voltage is set in such a way that the phase shift after the intensity modulation of the light of the second wavelength becomes 180°,
S_{MZ,XQ}=1 is established if the second bias voltage is set in such a way that the phase shift after the intensity modulation of the light of the second wavelength becomes 0°, and S_{MZ,XQ}=−1 is established if the second bias voltage is set in such a way that the phase shift after the intensity modulation of the light of the second wavelength becomes 180°,
S_{MZ,XP}=1 is established if the fifth bias voltage is set in such a way that the phase of the optical signal intensity-modulated by the second optical modulator becomes +90° with respect to the phase of the optical signal intensity-modulated by the first optical modulator, and S_{MZ,XP}=−1 is established if the fifth bias voltage is set in such a way that the phase of the optical signal intensity-modulated by the second optical modulator becomes −90° with respect to the phase of the optical signal intensity-modulated by the first optical modulator,
S_{MZ,YI}=1 is established if the third bias voltage is set in such a way that the phase shift after the intensity modulation of the light of the second wavelength becomes 0°, and S_{MZ,YI}=−1 is established if the third bias voltage is set in such a way that the phase shift after the intensity modulation of the light of the second wavelength becomes 180°,
S_{MZ,YQ}=1 is established if the fourth bias voltage is set in such a way that the phase shift after the intensity modulation of the light of the second wavelength becomes 0°, and S_{MZ,YQ}=−1 is established if the fourth bias voltage is set in such a way that the phase shift after the intensity modulation of the light of the second wavelength becomes 180°,
S_{MZ,YP}=1 is established if the sixth bias voltage is set in such a way that the phase of the optical signal intensity-modulated by the fourth optical modulator becomes +90° with respect to the phase of the optical signal intensity-modulated by the third optical modulator, and S_{MZ,YP}=−1 is established if the sixth bias voltage is set in such a way that the phase of the optical signal intensity-modulated by the fourth optical modulator becomes −90° with respect to the phase of the optical signal intensity-modulated by the third optical modulator, and
the optical modulator bias unit sets operating points of the respective first to fourth optical modulators by the first to fourth bias voltages, and the phase modulator bias unit sets operating points of the respective first and second phase modulators by the fifth and sixth bias voltages in such a way that the following equation is established if a value of S_{MZ,YI} is set to S_{X} and a value of S_{MZ,YI} is set to S_{Y}.
$$[ \begin{matrix}{S}_{MZ , XI} & 0 & 0 & 0 \\ 0 & {S}_{MZ , XQ} {S}_{MZ , XP} & 0 & 0 \\ 0 & 0 & {S}_{MZ , YI} & 0 \\ 0 & 0 & 0 & {S}_{MZ , YQ} {S}_{MZ , YP}\end{matrix} ] {T}_{RF} {T}_{R} = AP ( {Δϕ}_{X} , {Δϕ}_{Y} ) R ( {Δθ}_{0} ) [ \begin{matrix}{S}_{X} & 0 & 0 & 0 \\ 0 & \pm {S}_{X} & 0 & 0 \\ 0 & 0 & {S}_{Y} & 0 \\ 0 & 0 & 0 & \pm {S}_{Y}\end{matrix} ] {T}_{R} \qquad [ 3 ]$$

6. A wavelength conversion method comprising:
receiving an input optical signal of a first wavelength, which is polarization-multiplexed and quadrature-phase-modulated, and demodulating the input optical signal into an in-phase analog signal and a quadrature-phase analog signal relevant to a first polarization, and an in-phase analog signal and a quadrature-phase analog signal relevant to a second polarization; and
transmitting an output optical signal of a second wavelength different from the first wavelength, which is polarization-multiplexed and quadrature-phase-modulated, and which is obtained by multiplexing an in-phase optical signal of the first polarization obtained by intensity-modulating light of the second wavelength based on the in-phase analog signal relevant to the first polarization, a quadrature-phase optical signal of the first polarization obtained by intensity-modulating the light of the second wavelength based on the quadrature-phase analog signal relevant to the first polarization, an in-phase optical signal of the second polarization obtained by intensity-modulating the light of the second wavelength based on the in-phase analog signal relevant to the second polarization, and a quadrature-phase optical signal of the second polarization obtained by intensity-modulating the light of the second wavelength based on the quadrature-phase analog signal relevant to the second polarization,
wherein, in the output optical signal, a phase relationship between a component of the in-phase analog signal and a component of the quadrature-phase analog signal relevant to the first polarization and a phase relationship between a component of the in-phase analog signal and a component of the quadrature-phase analog signal relevant to the second polarization are maintained in the same phase relationship.
